(19) United States
(12) Patent Application Publication
(10) Pub. No.: US 2017/0220317 A1
(43) Pub. Date: Aug. 3, 2017

(54) ELECTRONIC APPARATUS AND CONTROL PROGRAM OF ELECTRONIC APPARATUS

(71) Applicant: SEIKO EPSON CORPORATION, Tokyo (JP)

(72) Inventor: Kikuo UENO, Shiojiri-shi (JP)

(21) Appl. No.: 15/414,168

(22) Filed: Jan. 24, 2017

(30) Foreign Application Priority Data
Jan. 29, 2016 (JP) 2016-015323

(51) Int. Cl. G06F 3/16; G06F 3/0484; G06F 3/0488

(52) U.S. Cl. CPC G06F 3/165; G06F 3/0488; G06F 3/04847; G06F 3/04842; G06F 3/167

(57) ABSTRACT

There is provided an electronic apparatus including a speaker; a touch panel type display that displays a screen constituent element relating to a sound; and a control unit that increases volume of the sound generated from the speaker according to a pinch-out operation with respect to the screen constituent element, and decreases the volume of the sound generated from the speaker according to a pinch-in operation with respect to the screen constituent element.

### CROSS-REFERENCE TO RELATED APPLICATIONS

The present application claims priority to Japanese Patent Application No. 2016-015323, filed Jan. 29, 2016, which is hereby incorporated by reference in its entirety.

### BACKGROUND

1. Technical Field

The present invention relates to an electronic apparatus and a control program thereof, and particularly a volume adjustment operation.

2. Related Art

In the related art, an electronic apparatus such as a PC and a smartphone having a function to read sentences displayed on a screen, is known. In addition, in JP-A-2015-219855, a technology in which a ratio of volume and the total volume in each sound source are adjusted according to components of designated coordinates of a user in a coordinate system set on a touch panel screen, is described.

However, in the electronic apparatus having a function to read sentences, a volume adjustment graphic user interface (GUI) is not necessarily disposed in the vicinity of a display region of a sentence to be read. Therefore, there are problems that it is difficult for users to notice existence of the volume adjustment GUI disposed at a position separated from the display region of a sentence and usability is poor.

### SUMMARY

An advantage of some aspects of the invention is to improve the usability at the time of volume adjustment in the electronic apparatus.

According to an aspect of the invention, there is provided an electronic apparatus including: a speaker; a touch panel type display that displays a screen constituent element relating to a sound; and a control unit that increases volume of the sound generated from the speaker according to a pinch-out operation with respect to the screen constituent element, and decreases the volume of the sound generated from the speaker according to a pinch-in operation with respect to the screen constituent element.

In a case of the aspect of the invention, a user performs the pinch-out operation or the pinch-in operation with respect to the screen constituent element displayed on the display such that it is possible to adjust the volume. The pinch-out operation is generally recognized as an operation for increasing an image in the related art, and intuitively easy to associate with an operation for increasing volume in the volume adjustment. In addition, conversely, the pinch-in operation is generally recognized as an operation for decreasing an image, and intuitively easy to associate with an operation for decreasing volume. By directly performing such an intuitive operation with respect to the screen constituent element relating to a sound, since it is possible to increase or decrease the volume, it is possible to improve usability at the time of volume adjustment.

### BRIEF DESCRIPTION OF THE DRAWINGS

The invention will be described with reference to the accompanying drawings, wherein like numbers reference like elements.

FIG. 1 is a block diagram showing a configuration of a tablet terminal.

FIGS. 2A to 2C are diagrams showing screens and operations according to a first embodiment.

FIGS. 3A and 3B are diagrams showing screens and operations according to a second embodiment.

FIG. 4 is a diagram showing a screen according to a third embodiment.

FIG. 5 is a diagram showing a screen according to a fourth embodiment.

FIGS. 6A and 6B are diagrams showing screens and operations according to other embodiments.

### DESCRIPTION OF EXEMPLARY EMBODIMENTS

Hereinafter, an embodiment of the invention will be described with reference to accompanying drawings. In the drawings, the same reference numerals are given to the corresponding constituent elements, and duplicate explanations are omitted.

### 1. First Embodiment

### 1-1. Configuration

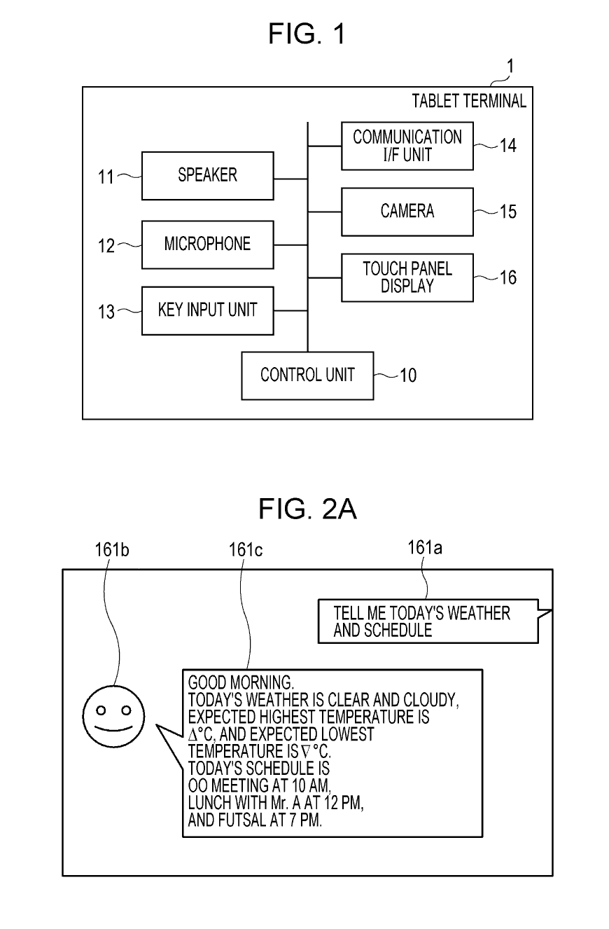

FIG. 1 is a block diagram showing a configuration of a tablet terminal 1 as an electronic apparatus of the invention. The tablet terminal 1 includes a control unit 10, a speaker 11 that generates a sound, a microphone 12 that collects the sound, a key input unit 13 including a power button and a home button, a communication I/F unit 14, a camera 15, a touch panel display (hereinafter, simply referred to as display) 16, and the like. The display 16 includes a display panel that displays various kinds of information under the control of the control unit 10, and a touch detection panel that is overlapped on the display panel. The display 16 detects contact on the display 16 by a human finger or the like by a well-known method such as an electrostatic capacitance method, a resistive film method, and an optical method. Then, the display 16 outputs information (for example, coordinates or the like of touch start position and touch end position) indicating the contact to the control unit 10. The control unit 10 specifies operations such as a tap operation, a swipe (drag) operation, a pinch-in operation, and a pinch-out operation, based on the information indicating the contact. The pinch-out operation is an operation to widen an interval between two fingers in contact with the display 16, and the pinch-in operation is an operation to narrow the interval between two fingers in contact with the display 16.

The communication I/F unit 14 includes a wireless communication interface for connecting to the Internet. The camera 15 includes a lens, an area image sensor, and an image processing circuit, images a subject, and generates image data.

The control unit 10 is configured by a CPU, a RAM, a ROM, a non-volatile memory, and the like, and a control program recorded in the ROM or non-volatile memory can be executed by the CPU by using the RAM or the non-volatile memory. The control program includes a display control function for displaying various screen constituent elements on the display 16, an operation detection function for detecting an operation on the display 16, a voice output control function for generating a sound from the speaker 11 based on a value or the like indicating voice data and volume, a voice input control function for recognizing voice based on the voice data obtained from the microphone 12, a communication control function for performing communication with other devices by controlling the communication I/F unit 14, a capture control function for obtaining image data indicating an image captured by the camera 15, and the like. By executing the control program, the control unit 10 can realize a function for adjusting the volume of the sound generated from the speaker 11 according to an operation with respect to the screen constituent elements relating to the sound displayed on the display 16.

### 1-2. Volume Adjustment

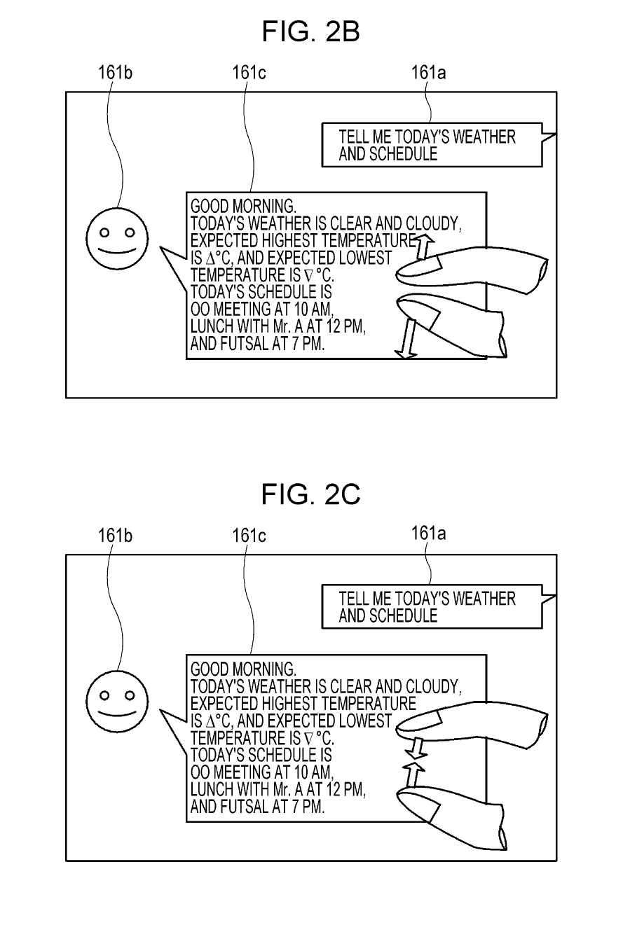

FIG. 2A is a diagram showing a screen display example of an application program realizing an assistant function by the voice. In a state where the application program is activated, for example, when a user speaks “tell me today's weather and schedule”, the control unit 10 analyzes the voice data indicating the speech obtained from the microphone 12, obtains content of the speech, and displays a balloon 161a including a character string indicating the content of the speech. In addition, the control unit 10 obtains information that is material of a response with respect to the content from a predetermined server apparatus through, for example, the communication I/F unit 14, generates a response sentence and voice data indicating the response sentence, displays a balloon 161c including a character string indicating the response sentence, and outputs a voice (synthesized voice) of the response sentence from the speaker 11 based on voice data indicating the response sentence. In the embodiment, the balloon 161c is the screen constituent element relating to a sound, and corresponds to a balloon including a character or a symbol indicating the sound.

During an output period of the voice indicating the response sentence of the balloon 161c, when it is detected that the pinch-out operation is performed with respect to the balloon 161c as shown in FIG. 2B, the control unit 10 increases volume of the voice indicating the response sentence of the balloon 161c being output from the speaker 11. In addition, during outputting of the voice indicating the response sentence of the balloon 161c, when it is detected that the pinch-in operation is performed with respect to the balloon 161c as shown in FIG. 2C, the control unit 10 decreases the volume of the voice indicating the response sentence of the balloon 161c being output from the speaker 11. As a determination method of the volume after the operation, a volume by a predetermined amount that is determined in advance with respect to, for example, one pinch-out operation or one pinch-in operation may be increased or decreased, or the volume may be changed by being interworked with a distance between two fingers in, for example, the pinch-out operation or the pinch-in operation.

A configuration in which a volume adjustment GUI is provided separately from the balloon 161c is known in related art. However, there is a problem that it is difficult for users to know existence of the volume adjustment GUI, a relationship between the balloon and the volume adjustment GUI, or the like. In addition, as a specific example of the volume adjustment GUI, for example, a slider is typically known in the related art. However, it is not preferable to constantly display the slider because the slider occupies the screen unnecessarily. In addition, in the related art, for example, a configuration in which a volume adjustment slider is displayed by tapping a speaker icon displayed on the screen and the volume is adjusted by dragging the thumb of the slider is known. However, in the related art, at least an operation of two steps is required. In a case of the embodiment, since the user can increase or decrease the volume of the voice indicated by characters within the balloon 161c by performing the pinch-out operation or the pinch-in operation which is easy to intuitively understand with respect to directly the balloon 161c, it is convenient for the user compared to the configuration in the related art. In addition, in the case of the embodiment, since the balloon 161c functions as the volume adjustment GUI, and the control unit 10 does not need to dispose the volume adjustment GUI separately from the balloon 161c, the control unit 10 can effectively use a screen compared to a configuration where the volume adjustment GUI is separately displayed. A size of the balloon 161c itself and a size of the character within the balloon 161c may increase or decrease in conjunction with increase or decrease of the volume according to the pinch-out operation and the pinch-in operation, or only the volume may increase without changing the size of the balloon and the character. In addition, during the pinch-out operation or during the pinch-in operation with respect to the balloon 161c, a numerical value indicating the current volume may be displayed in the vicinity of the balloon 161c.

An image 161b is an icon (image indicating sound source) indicating a virtual person who speaks a sentence within the balloon 161c. However, the icon may be not necessarily displayed. That is, the balloon 161c may be displayed.

In this example, the volume of the voice being output is adjusted by the pinch-out operation or the pinch-in operation during the output period of the voice. However, the pinch-out operation may be a trigger of starting voice output. Specifically, for example, after voice data of “tell me today's weather and schedule” by a user is obtained, the control unit 10 displays the balloon 161c including a character string indicating the response sentence such that outputting of the voice indicating the response sentence within the balloon 161c may be started according to the pinch-out operation with respect to the balloon 161c by the user. In addition, the volume at this time may be determined by an interval between the two fingers of the pinch-out operation. The trigger of starting voice output is not limited to the pinch-out operation, and, for example, may be a tap operation with respect to the balloon 161c. In addition, a configuration in which the voice output is started by the tap operation with respect to the balloon 161c, and then the volume is increased according to the pinch-out operation or the pinch-in operation may be implemented.

### 2. Second Embodiment

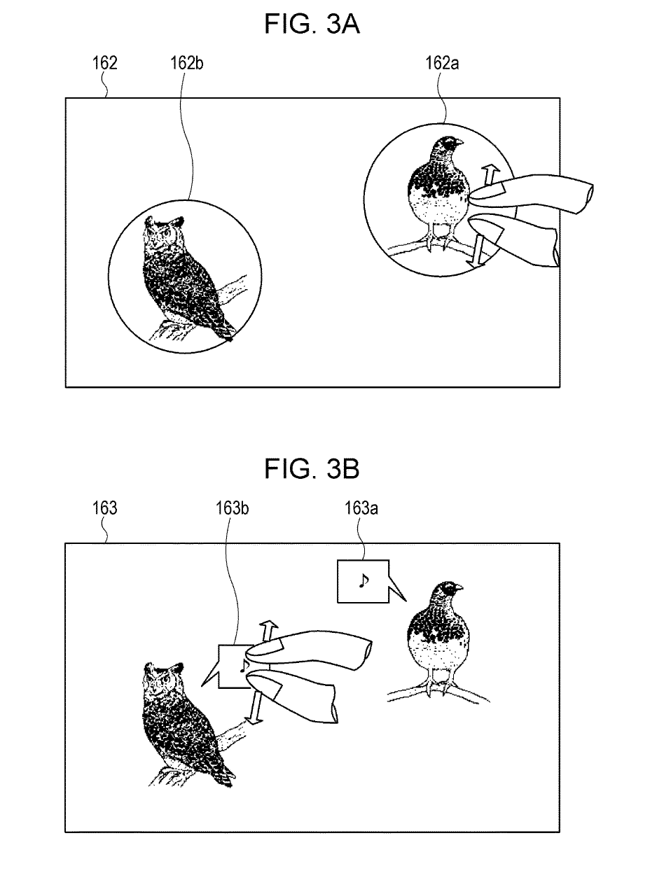

FIG. 3A is a diagram showing a screen display example according to a second embodiment. In the embodiment, for example, the tablet terminal 1 is disposed in an exhibition corner of a natural museum or the like, and displays a screen shown in FIG. 3A on the display 16. An image 162a indicating a first bird and an image 162b indicating a second bird are included on a screen 162 shown in FIG. 3A. In addition, first voice data indicating cry of the first bird and second voice data indicating cry of the second bird are recorded in the non-volatile memory. In addition, the control unit 10 reproduces repeatedly the first voice data and the second voice data, and continuously outputs the cry of the first bird and the cry of the second bird from the speaker 11 at the same time. The image 162a and the image 162b are the screen constituent elements relating to a sound, and correspond to an image indicating a sound source.

In a state where the first voice data and the second voice data are reproduced, and the cry of the first bird and the cry of the second bird are output from the speaker 11, for example, when it is detected that a user performs the pinch-out operation with respect to the image 162a as shown in FIG. 3A, the control unit 10 increases the reproduction volume of the first voice data. In addition, when it is detected that the pinch-in operation is performed with respect to the image 162a, the control unit 10 decreases the reproduction volume of the first voice data. In addition, when it is detected that the pinch-out operation is performed with respect to the image 162b, the control unit 10 increases the reproduction volume of the second voice data, and when it is detected that the pinch-in operation is performed with respect to the image 162b, the control unit 10 decreases the reproduction volume of the second voice data.

If the volume adjustment GUIs corresponding to each of the sound sources (first bird and second bird) are disposed, when the sound sources are disposed in the vicinity of images (162a and 162b) indicating each of the sound sources, there is a possibility that it is not preferable in terms of a screen design. However, in a case where each volume adjustment GUI is disposed at a position separated from an image indicating each sound source, there is a possibility that a correspondence relationship with each sound source becomes difficult for the user to understand. According to the embodiment, by performing a direct operation with respect to the images (162a and 162b) indicating the sound source, the reproduction volume of a plurality of sound sources can be individually adjusted, and then this case is easy to understand, and convenient. This effect is remarkable as the number of the sound sources increase.

As a screen 163 shown in FIG. 3B, balloons 163a and 163b including a symbol indicating a sound may be displayed in the vicinity of the image indicating the sound source. In this case, the control unit 10 may increase or decrease the volume of the voice data corresponding to a balloon that is operated according to detection of the pinch-out operation or the pinch-in operation with respect to the balloon 163a or the balloon 163b.

### 3. Third Embodiment

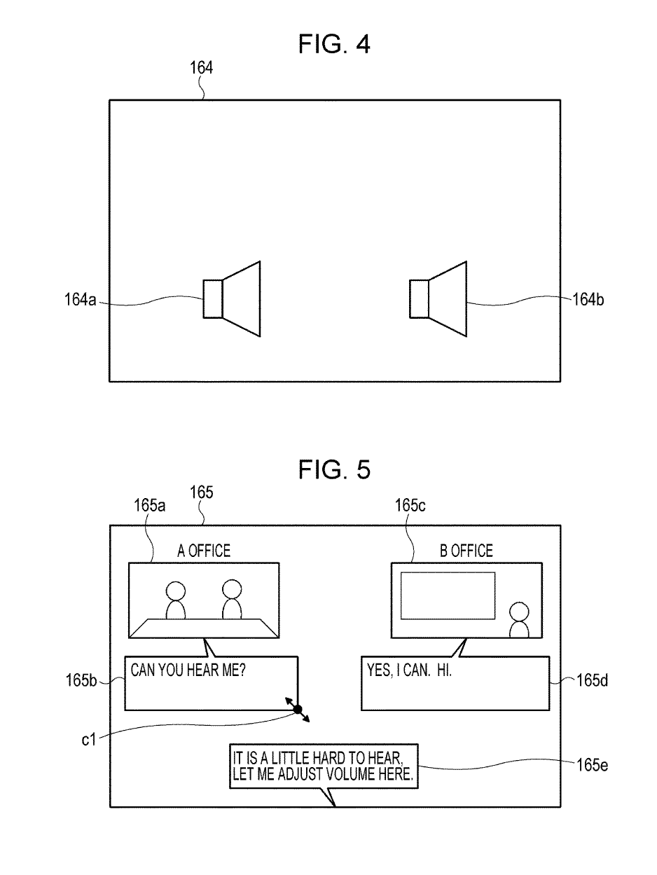

FIG. 4 is a diagram showing a volume adjustment screen 164 according to a third embodiment. In the embodiment, the speaker 11 of the tablet terminal 1 is configured by two speakers. The icons 164a and 164b displayed on the volume adjustment screen 164 indicate the two speakers, respectively, the icon 164a corresponds to the first speaker among the two speakers, and the icon 164b corresponds to the second speaker. In the embodiment, the icon 164a and the icon 164b are the screen constituent elements relating to a sound, and correspond to the image indicating the sound source.

For example, when it is detected that a user performs the pinch-out operation with respect to the icon 164a, the control unit 10 increases the volume of the first speaker. As a result, balance between the two speakers is changed compared to a case before the pinch-out operation. In addition, for example, when the pinch-in operation with respect to the icon 164a is detected, the control unit 10 decreases the volume of the first speaker.

In a case of the embodiment, and in a case where a plurality of (equal to or greater than two) speakers exist, by performing the pinch-out operation or the pinch-in operation with respect to an icon corresponding to each speaker, the user can increase or decrease the volume of the plurality of speakers, and change volume balance of the plurality of speakers.

The control unit 10 may increase the volume of both the first speaker and the second speaker according to the pinch-out operation with respect to an icon (not shown) indicating the speaker 11 configured by the first speaker and the second speaker, and decrease the volume of both the speakers according to the pinch-in operation with respect to the icon (that is, entirety of volume may be increased or decreased).

### 4. Fourth Embodiment

In the embodiments, an example in which the volume is adjusted by the pinch-out operation and the pinch-in operation with respect to a touch panel type display is mentioned. However, the volume can be adjusted by an operation using a mouse with respect to a balloon. In the fourth embodiment, the mouse is wirelessly connected to the tablet terminal 1. A screen 165 shown in FIG. 5 is displayed on the display 16 of the tablet terminal 1. The screen 165 shows a video chat screen. The control unit 10 obtains video data and character data indicating a speech voice from a first terminal through the communication I/F unit 14, displays a video indicated by the video data on a region 165a, outputs the voice indicated by the video data from the speaker 11, and displays a sentence indicated by the character data in a balloon 165b. In addition, the control unit 10 obtains the video data and the character data indicating the speech voice from a second terminal through the communication I/F unit 14, displays the video indicated by the video data on the region 165c, outputs the voice indicated by the video data from the speaker 11, and displays a sentence indicated by the character data in the balloon 165d. The control unit 10 captures the video by controlling the microphone 12 and the camera 15, generates the character data indicating the speech voice included in the video, and transmits the video data and the character data to the first terminal and the second terminal through the communication I/F unit 14. In addition, the character string is displayed on the balloon 165e based on the character data. In the embodiment, the video image displayed on the region 165a and the video image displayed on the region 165c correspond to images indicating the sound source. In addition, the balloon 165b and the balloon 165d correspond to balloons including a character indicating the sound generated from the sound source.

The user of the tablet terminal 1 operates the mouse such that, the control unit 10 may increase the volume of the voice based on the video data obtained from the first terminal, for example, by dragging an outer peripheral portion of the balloon 165b (for example, corner portion c1) toward an outside of the balloon 165b. In addition, conversely, the control unit 10 may decrease the volume by dragging the outer peripheral portion of the balloon 165b (for example, corner portion c1) toward an inside of the balloon 165b. Of course, the volume of the voice may be increased or decreased based on the video data obtained from the second terminal according to the same operation with respect to the balloon 165d corresponding to the second terminal.

In this manner, the user performs an individual drag operation with respect to the plurality of balloons such that it is possible to easily increase or decrease the volume of the sound corresponding to each balloon. A function for displaying the character string indicating the voice in the balloons 165b, 165d, and 165e may be omitted. In this case, the same operation is performed with respect to the regions 165a and 165c on which the video image is displayed such that the control unit 10 may also increase or decrease the volume of the voice in a corresponding video.

### 5. Other Embodiments

It should be noted that the technical scope of the invention is not limited to the above-described embodiments, and it is obvious that various modifications can be made without departing from the gist of the present invention. For example, it can be applied to various apparatuses such as printers and scanners other than tablet terminals as electronic apparatuses. Particularly, in an electronic apparatus equipped with a voice guide function, it is conceivable to apply the invention to adjust the volume or the like of the voice. The invention can be applied not only to a single electronic apparatus but also to a volume adjustment system including a speaker, a touch panel display (or operation input device and display device), and a control device.

In the specification, “the sound source” means a thing that generates a sound. For example, the sound source may be a thing that exists in nature such as a person, an animal, a musical instrument, and a speaker, or may be a virtual person, animal, or musical instrument that emits synthesized voice. “The image indicating the sound source” may be a photograph of the sound source existing in the nature, or may be a character or a symbol reminiscent of an illustration imitating an actual sound source or the actual sound source. In addition, “the image indicating the sound source” may be an illustration, a character, or a symbol reminiscent of a virtual sound source. Since the balloon indicates the content of the sound generated from the sound source by the included character or symbol, the balloon does not correspond to “the image indicating the sound source”.

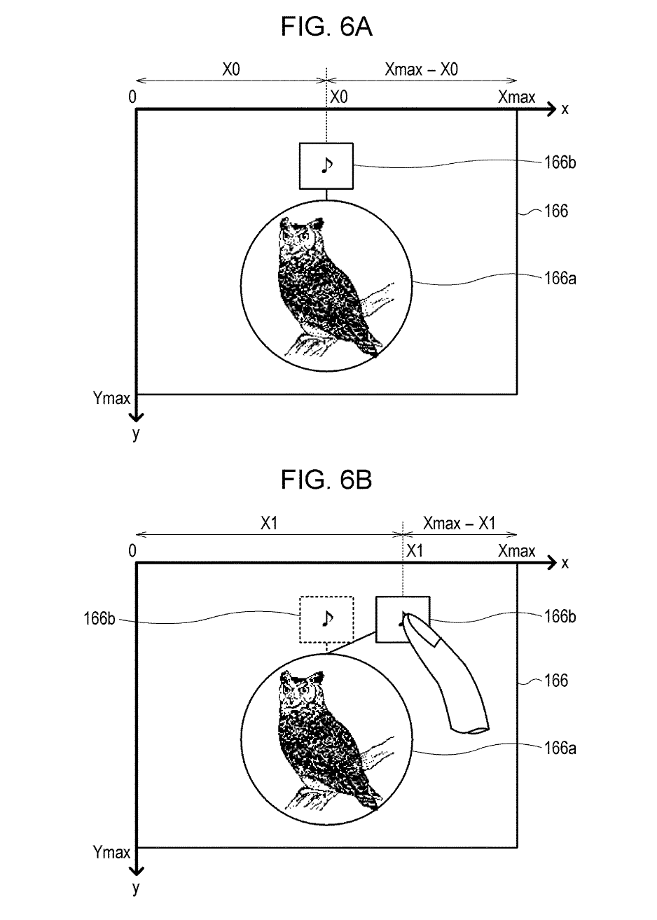

In addition, for example, in a case where the plurality of speakers are included, when it is detected that an operation (drag, swipe, or the like) by which a balloon is moved is performed, the volume balance of the plurality of speakers generating a sound indicated by a character or a symbol included in the balloon may be changed according to a position of a balloon after movement. For example, it is assumed that the speaker 11 of the tablet terminal 1 is configured by left and right two speakers, and a screen 166 shown in FIG. 6A is displayed on the display 16. On the screen 166, as shown in FIG. 6A, an x axis is set in parallel with the horizontal (left and right directions) direction of the screen, a y axis is set in parallel with the vertical direction (up and down directions) of the screen. An image 166a showing a bird is displayed at the center in a direction in parallel with the x axis of the screen 166, and a balloon 166b extended from the image 166a is displayed. It is assumed that a length in the direction in parallel with the x axis of the screen 166 is Xmax, an x component of coordinates of a representative point (for example, center of gravity) of the balloon 166b before movement shown in FIG. 6A is X0, and an x component of coordinates of a representative point of the balloon 166b after movement shown in FIG. 6B is X1. The control unit 10 changes the balance of the volume in the left and right speakers in accordance with the movement of the balloon from X0: (Xmax−X0) to X1: (Xmax−X1). The balance may be changed by an operation that moves the image 166a. Even in a case where there are three speakers or more, by an operation of moving the balloon and the image similarly, the balance of a speaker corresponding to a position close to the balloon and the image is increased and the balance of a speaker corresponding to a position far away from the balloon and the image is decreased. In this case, the balance of the speaker may be displayed by numerals on a side of the balloon or an end portion of the screen 166 in the direction of movement of the balloon.

In addition, the invention can be applied to scenes of foreign language learning. For example, when a user taps a word which is not understood at the time of reading a book written by a foreign language by using the tablet terminal 1, meaning and a phonetic symbol of the word may be displayed within the balloon which is displayed from the word. In addition, by performing the pinch-out operation on a portion of the phonetic symbol, the user may also reproduce the voice indicating the word by a required volume in accordance with an environment. For example, the volume is determined according to an interval between the two fingers in the pinch-out operation.

In addition, the screen constituent element relating to a sound may be the volume adjustment GUI itself such as a slider for adjusting the volume. That is, the user may increase or decrease the volume by performing the pinch-out operation or the pinch-in operation with respect to the slider. In addition, for example, the character or the symbol indicating the sound may be a musical score. Since “the balloon including the character or the symbol indicating the sound” or “the image indicating the sound source” exemplified in the embodiment indicates the content of the sound or the sound source, it can also be mentioned that it is “a screen constituent element indicating information irrelevant to the volume.” Meanwhile, a volume adjustment slider indicating information relating to the volume does not correspond to “the screen constituent element indicating information irrelevant to the volume” (corresponds to “screen constituent element relating to sound”).

Also, functions of each unit described in the aspects are realized by hardware resources whose functions are specified by the configuration itself, hardware resources whose functions are specified by programs, or a combination thereof. In addition, functions of these units are not limited to those realized by hardware resources that are physically independent of each other. In addition, the invention is not limited to devices that realize all the functions with a single device, but may be a device including a plurality of devices in which functions are distributed in separate devices, and the plurality of devices cooperate to realize the whole function.

What is claimed is:

1. An electronic apparatus comprising:
a speaker;
a touch panel type display that displays a screen constituent element relating to a sound; and
a control unit that increases volume of the sound generated from the speaker according to a pinch-out operation with respect to the screen constituent element, and decreases the volume of the sound generated from the speaker according to a pinch-in operation with respect to the screen constituent element.

2. The electronic apparatus according to claim 1,
wherein the screen constituent element is an image indicating a sound source.

3. The electronic apparatus according to claim 1,
wherein the screen constituent element is a balloon including a character or a symbol indicating the sound, and
wherein the control unit increases the volume of the sound according to the pinch-out operation with respect to the balloon, and decreases the volume of the sound according to the pinch-in operation with respect to the balloon.

4. The electronic apparatus according to claim 1,
wherein the display displays a plurality of the screen constituent elements, and
wherein the control unit increases or decreases the volume of the sound corresponding to the screen constituent element, according to the pinch-out operation or the pinch-in operation with respect to any screen constituent element among the plurality of screen constituent elements.

5. The electronic apparatus according to claim 1,
wherein the display displays a plurality of the screen constituent elements corresponding to a plurality of the speakers, respectively, and
wherein the control unit changes volume balance of the plurality of speakers according to the pinch-out operation or the pinch-in operation with respect to any screen constituent element among the plurality of screen constituent elements.

6. The electronic apparatus according to claim 1,
wherein the control unit starts outputting of the sound from the speaker according to the pinch-out operation or a tap operation with respect to the screen constituent element.

7. An electronic apparatus comprising:
a speaker;
a display that displays a screen constituent element indicating information irrelevant to volume; and
a control unit that increases or decreases the volume of a sound generated from the speaker according to an operation with respect to the screen constituent element.

8. The electronic apparatus according to claim 7,
wherein the display displays a plurality of the screen constituent elements, and
wherein the control unit increases or decreases the volume of a sound corresponding to the screen constituent element according to an operation with respect to any screen constituent element among the plurality of screen constituent elements.

9. The electronic apparatus according to claim 7,
wherein when it is detected that an operation for moving the screen constituent element is performed, the control unit changes volume balance of a plurality of the speakers generating the sound corresponding to the screen constituent element, according to a position of the screen constituent element after movement.

10. A non-volatile storage medium of storing a control program causing an electronic apparatus to realize a function:
increasing volume of a sound generated from a speaker according to a pinch-out operation with respect to a screen constituent element relating to the sound displayed on a display, and
decreasing the volume of the sound generated from the speaker according to a pinch-in operation with respect to the screen constituent element.

11. A non-volatile storage medium of storing a control program causing an electronic apparatus to realize a function:
increasing or decreasing volume of a sound generated from a speaker according to an operation with respect to a screen constituent element indicating information irrelevant to the volume displayed on a display.
